(19) United States
(12) Patent Application Publication
(10) Pub. No.: US 2007/0040683 A1
(43) Pub. Date: Feb. 22, 2007

(54) Light-activated RFID tag

(76) Inventors: Neal Oliver, Florham Park, NJ (US); Arthur Sheiman, Mountain Lakes, NJ (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 11/209,285

(22) Filed: Aug. 22, 2005

(51) Int. Cl. G08B 13/14

(52) U.S. Cl. 340/572.1

(57) ABSTRACT

Various embodiments of the invention may use the state of the output of a light sensor to permit transmission of an identification code from an activated radio frequency identification (RFID) tag. Alternately, the state of the output of the light sensor may be used to select one of multiple identification codes for transmission from the activated RFID tag.

### BACKGROUND

Radio frequency identification (RFID) technology has been used in many different applications to identify specific objects that are in proximity, without requiring line-of-sight access. RFID readers may transmit a signal to activate RFID tags that are within a certain range, causing those tags to transmit their identification codes back to the reader. However, privacy concerns have been raised about the use of this technology, since the tags may be read surreptitiously, even long after the original need has passed. Unauthorized reading is especially a concern if the tags are used to identify objects that require a certain amount of security, such as confidential documents. Restricted access documents (e.g., secret military plans) and/or restricted use documents (e.g., passports and driver's licenses) may be examples, but there are many other types of objects that are currently not considered suitable for RFID tag identification because of the possibility of their unauthorized detection and/or identification. This effectively limits the overall usefulness of RFID technology.

### BRIEF DESCRIPTION OF THE DRAWINGS

Some embodiments of the invention may be understood by referring to the following description and accompanying drawings that are used to illustrate embodiments of the invention. In the drawings:

FIG. 1 shows a diagram of an RFID tag with a light sensor, according to an embodiment of the invention.

FIGS. 2A-2E show examples of various light sensors that may be used with the RFID tag of FIG. 1, according to various embodiments of the invention.

FIG. 3 shows a flow diagram of a method of operation, according to an embodiment of the invention.

FIG. 4 shows a flow diagram of a method of operation, according to another embodiment of the invention.

FIG. 5 shows a system with an object to be identified by an associated RFID tag, according to an embodiment of the invention.

### DETAILED DESCRIPTION

In the following description, numerous specific details are set forth. However, it is understood that embodiments of the invention may be practiced without these specific details. In other instances, well-known circuits, structures and techniques have not been shown in detail in order not to obscure an understanding of this description.

References to “one embodiment”, “an embodiment”, “example embodiment”, “various embodiments”, etc., indicate that the embodiment(s) of the invention so described may include particular features, structures, or characteristics, but not every embodiment necessarily includes the particular features, structures, or characteristics. Further, some embodiments may have some, all, or none of the features described for other embodiments.

In the following description and claims, the terms “coupled” and “connected,” along with their derivatives, may be used. It should be understood that these terms are not intended as synonyms for each other. Rather, in particular embodiments, “connected” may be used to indicate that two or more elements are in direct physical or electrical contact with each other. “Coupled” may mean that two or more elements co-operate or interact with each other, but they may or may not be in direct physical or electrical contact.

The term “processor” may refer to any device or portion of a device that processes electronic data from registers and/or memory to transform that electronic data into other electronic data that may be stored in registers and/or memory. A “computing platform” may comprise one or more processors.

Within the context of this document, an RFID tag may be defined as comprising an RFID antenna (to receive an incoming signal that serves to query the RFID tag and to transmit a response in the form of a modulated radio frequency signal), and an RFID tag circuit (which may include circuitry to store an identification code for the RFID tag, circuitry to transmit that code through the antenna, and in some embodiments a power circuit to collect received energy from the incoming radio frequency signal and provide that energy to power the operations of the RFID tag circuit).

As used herein, unless otherwise specified the use of the ordinal adjectives “first”, “second”, “third”, etc., to describe a common object, merely indicate that different instances of like objects are being referred to, and are not intended to imply that the objects so described must be in a given sequence, either temporally, spatially, in ranking, or in any other manner.

Various embodiments of the invention may be implemented in one or a combination of hardware, firmware, and software. The invention may also be implemented as instructions stored on a machine-readable medium, which may be read and executed by a computing platform to perform the operations described herein. A machine-readable medium may include any mechanism for storing, transmitting, or receiving information in a form readable by a machine (e.g., a computer). For example, a machine-readable medium may include, but is not limited to, read only memory (ROM); random access memory (RAM); magnetic disk storage media; optical storage media; flash memory devices. A machine-readable medium may also include a tangible medium through which electrical, optical, acoustical or other form of propagated signals representing the instructions may pass, such as antennas, optical fibers, communications interfaces, and others.

Some embodiments of the invention may use a light sensor to control transmission from a radio frequency identification (RFID) tag, so that the tag will not transmit in response to a signal from an RFID reader unless the light sensor detects light that has certain characteristics. For example, in some embodiments such an RFID tag might be temporarily prevented from transmitting by placing it within a box, envelope, closed book, or other container that sufficiently shields the sensor from light until the container is opened. Further, in various embodiments the tag may be affected by light within a certain range of intensity and/or by light within a certain range of wavelengths and/or by light meeting certain timing requirements (e.g., duration). In still other embodiments, the detection of light having the defined characteristics may be used in the opposite manner, i.e., to prevent transmission by the tag, while the absence of such light may permit the tag to respond with a transmission. Further, is some embodiments the RFID tag may transmit one code if light having the defined characteristics is detected, while the RFID tag may transmit another code if light having those characteristics is not detected.

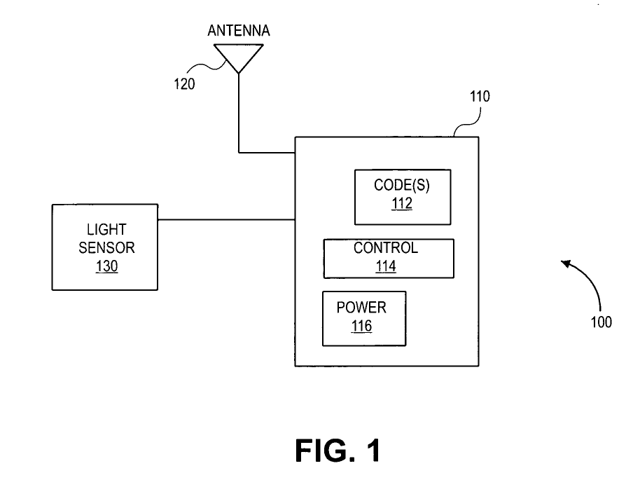

FIG. 1 shows a diagram of an RFID tag with a light sensor, according to an embodiment of the invention. In the illustrated embodiment, RFID tag 100 comprises RFID tag circuit 110, antenna 120, and light sensor 130. Although the antenna and light sensor are described as being part of the RFID tag in this example, in other descriptions and/or other embodiments they may be described as separate items. Such difference in labeling should not be interpreted as a limitation on the scope of various embodiments of the invention. Although the tag circuit 110, light sensor 130, and antenna 120 are described as separate items, in some embodiments two or more of these items may be integrated into a single package or single integrated circuit.

Antenna 120 may be used to received incoming signals, transmit outgoing signals, and in some embodiments may also be used to collect energy from the incoming signal which may be accumulated in a power circuit until sufficient energy has been collected to operate the RFID tag 100. The antenna 120 may be of any size, shape, and configuration that is suitable for use in the RFID tag 100.

Tag circuit 110 may include one or more identification (ID) codes 112 that may be transmitted by tag 100 when the tag circuit 110 is activated and receives the proper signal from a light sensor. The ID code(s) may be of any feasible length and/or format for RFID tags, and when received by an RFID reader may be used to identify the transmitting RFID tag 100. The reader, or an associated computer system, may then identify an object to which the RFID tag 100 is attached by looking up the ID code in a database. The antenna 120 may be used to transmit the ID code in the form of a modulated radio frequency signal when the RFID tag is queried by an RFID reader. The RFID tag circuit 110 may also comprise a control circuit 114 to control operations of other circuits within RFID tag 100. In some embodiments (e.g., so-called ‘passive’ tags) the RFID tag circuit 110 may be activated when an incoming signal of the proper characteristics is received by the antenna 120, and the received energy from that signal is accumulated in a power circuit 116 until there is enough accumulated electrical energy to power the RFID tag circuit. In other embodiments (e.g., so-called ‘active’ tags) the RFID tag circuit 110 may also be activated when an incoming signal of the proper characteristics is received by the antenna 120, but power for the RFID tag circuit 110 may come from a battery or other local power source.

In some embodiments, “transmitting” an ID code may comprise modulating and reflecting an incoming radio signal from the antenna, so that the transmission may be considered to be powered by the received signal. In other embodiments, transmitting may comprise sending enough electrical energy to the antenna from an internal power circuit to power the transmission. In some embodiments, the RFID tag may be considered activated whenever the power circuit has accumulated enough electrical energy from the received signal to power the RFID tag circuit. In other embodiments, the RFID tag may be considered activated only if the received signal is addressed to the RFID tag.

Once the RFID tag circuit 110 is activated, transmission from the RFID tag 100 may be controlled by the state of a signal from light sensor 130. In some embodiments the RFID tag 100 may transmit an ID code if the tag circuit 110 is activated and also receives the proper signal from a light sensor, while in other embodiments the RFID tag 100 may not transmit an ID code if tag circuit 110 is not activated and/or does not receive that proper signal from the light sensor. In some other embodiments, tag 100 may transmit one ID code if the RFID tag circuit 110 is both activated and receives the proper signal from the light sensor, but tag 100 may transmit another ID code if the RFID tag circuit 110 is activated but does not receive that proper signal from the light sensor. If tag circuit 110 is not activated, tag 100 may not transmit regardless of the state of the signal from light sensor 130. Note: within the context of this document, the term ‘activate’ may be used to describe receiving a signal with the proper characteristics from an RFID reader, so that receipt of that signal, plus receipt of a signal having the proper characteristics from a light sensor, will permit the RFID tag circuit to transmit through the antenna. Such proper characteristics (of the signal from the RFID reader) may include one or more of the following: 1) sufficient signal strength, 2) sufficient signal strength within a certain range of wavelengths, 3) an encoded address or other code directed to the RFID tag, 4) etc.

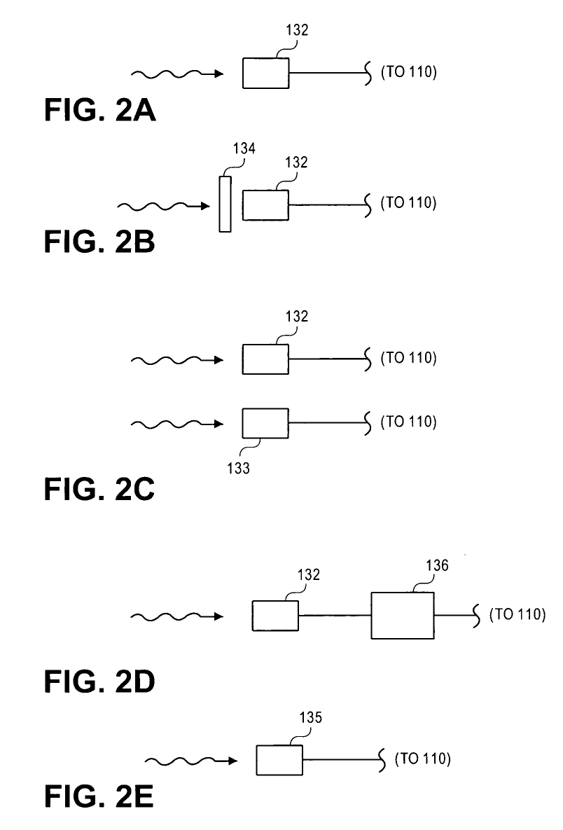

FIGS. 2A-2E show examples of various light sensors that may be used with the RFID tag of FIG. 1, according to various embodiments of the invention. In FIG. 2A, a light detector 132 may detect the light that is shown coming in from the left. If the light is sufficiently strong, the light detector may output a signal to RFID tag circuit 110 indicating that fact. In some embodiments, the signal to the tag circuit may be a binary signal, with one state indicating the detected light is above a certain threshold and the other state indicating the light is not above that threshold, but other embodiments may use other techniques. The light detector may be more sensitive to a certain range of wavelengths (such as light in the visible and/or non-visible spectrum), depending on its intended use.

FIG. 2B shows a filter 134 to filter out some of the light that reaches detector 132. The filter may be of various types, such as but not limited to: 1) a bandpass filter to pass a certain range of wavelengths but attenuate other wavelengths, 2) a polarizing filter to pass polarized light of a certain orientation, 3) a darkening filter to reduce the desired light level to an intensity suitable for the detector, 4) etc.

FIG. 2C shows two detectors 132 and 133, so that each detector may indicate light having different characteristics. For example, one detector may indicate a light intensity above a certain lower level, while the other detector may indicate a light intensity below a certain higher level. The two detectors in combination could therefore detect if the light intensity was within a certain range of intensity. In another example, two different wavelengths of light could be detected (e.g., a red laser light and a green laser light might be required to enable the RFID tag circuit).

FIG. 2D shows an auxiliary circuit 136 to work in conjunction with the output of the light detector 132. This circuit may perform various operations, such as timing (e.g., no signal to the tag circuit unless the detected light meets certain timing constraints such as minimum duration).

FIG. 2E shows a light sensor in the form of one or more photovoltaic cells to provide a voltage output. In this embodiment, cell(s) 135 may convert light into electrical energy, which may then be used to power RFID tag circuit 110. RFID tag 100 may still rely upon a combination of receiving a proper signal from an RFID reader and receiving a proper signal from a light sensor before it will transmit a response, but in this embodiment the signal from cell(s) 135 rather than the signal from the RFID reader may be used to provide operational power to the RFID tag circuit.

The light sensors shown in FIGS. 2A-2E do not represent a comprehensive list of possibilities; other variations may also be used in conjunction with the RFID tag circuit. Further, the different types of light detectors may be used in any combination to achieve an indication of the desired characteristics of the detected light. Any circuitry that is necessary to perform the indicated operations may be located in any convenient place, such as in the detector, in the RFID tag circuit, and/or between the detector and RFID tag circuit.

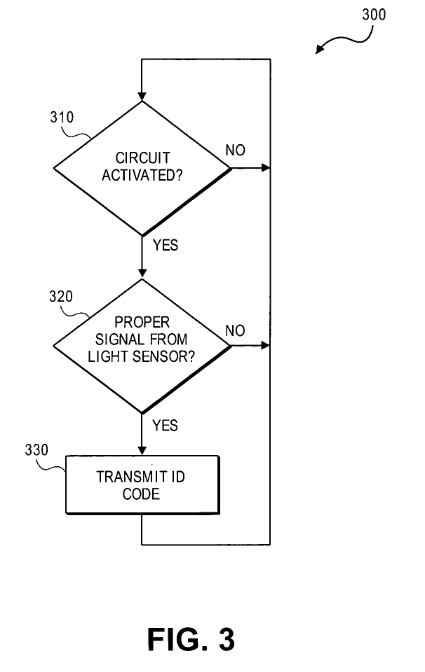

FIG. 3 shows a flow diagram of a method of operation, according to an embodiment of the invention. In the flow diagram 300, a tag circuit may be activated at 310 by receiving an incoming signal with the proper characteristics through the antenna. In some embodiments, the ‘proper’ characteristics may be that the signal contains an address that is directed to this particular RFID tag. In some embodiments, the proper characteristics may be that the frequency and/or amplitude of the incoming signal are within particular ranges. In some embodiments, the proper characteristics may simply be that enough of the electrical energy received by the antenna accumulates in a power circuit to permit the RFID tag circuitry to operate. If the tag circuit is not activated, the flow diagram may loop at 310 until it is activated.

Once the tag circuit is activated, at 320 it may be determined whether a signal from the light sensor is in a proper state to enable the RFID tag to transmit an identification code. Just what the proper state is may depend on how the RFID tag is designed to operate. In various embodiments, the light sensor (which may include some associated circuitry to help perform the indicated functionality) may send a signal to the RFID tag circuit whose state is based on various conditions, such as but not limited to one or more of the following: 1) the intensity of the detected light (whether the intensity is above a certain value, below a certain value, or within a certain range of values), 2) the duration of the detected light (whether the light is detected for longer than a certain duration, less than a certain duration, or within a certain range of durations, 3) the frequency of the detected light (whether the frequency is above a certain value, below a certain value, or within a certain range of values), 4) whether the detected light is polarized, 5) etc. The light sensor may employ various elements to make the aforementioned determinations, such as but not limited to optical filters, clock circuits, bandpass filter circuits, etc.

If the signal from the light sensor is in the proper state, the RFID tag may transmit its ID code through the antenna at 330. Operations may then return to 310. In come embodiments, transmission of the ID code may be repeated as long as the circuit is both activated and the signal from the light sensor has the proper state.

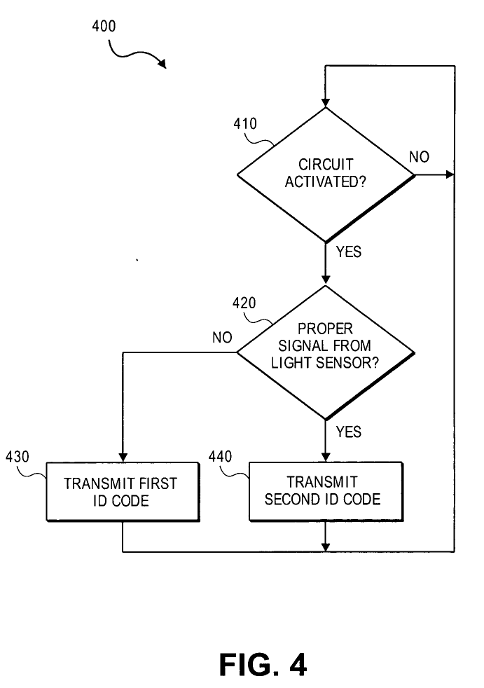

FIG. 4 shows a flow diagram of a method of operation, according to another embodiment of the invention. The flow diagram 400 in FIG. 4 may be similar to flow diagram 300 in FIG. 3, except that the operation of FIG. 4 describes transmitting one code if the signal from the light sensor is in one state, or transmitting a different code if the signal from the light sensor is in another state. In the flow diagram 400, a tag circuit may be activated at 410 by receiving an incoming signal with the proper characteristics, similar to the operation described for block 310 in FIG. 3. If the tag circuit is not activated, the flow diagram may loop at 410 until it is activated.

Once the tag circuit is activated, at 420 it may be determined whether the signal from the light sensor has the proper state. Just what the proper state is may depend on how the RFID tag is designed to operate, similar to the description of block 320 in FIG. 3. In various embodiments, the light sensor (which may include some associated circuitry to help perform the indicated functionality) may send a signal to the RFID tag circuit whose state depends on various conditions, such as those described for block 320 in FIG. 3.

If the light sensor is determined to be in a particular state at 420 (e.g., it does not detect light above a certain threshold intensity), then the RFID tag may transmit a particular ID code at 430. If the light sensor is determined to be in another state at 420 (e.g., it does detect light above a certain threshold), then the RFID tag may transmit a different particular ID code at 440. In either case, the operation may then return to 410. The operation may repeat this loop as long as the RFID tag circuit is activated.

Different usage models may be supported by the two different processes shown in FIGS. 3 and 4. For example, if the existence of an object is to be hidden from RFID readers until it is ready to be read, the operation of FIG. 3 might be used. By placing the tagged object into a dark place (such as an opaque envelope, a closed briefcase, a coat pocket, etc.), and not bringing the object into the light until it is deemed safe to read the RFID tag with an RFID reader, the existence of the tagged object may be kept secret from non-authorized RFID readers while the object is in transit. On the other hand, if the existence of the tagged object is not to be hidden, but the details of the specific tagged object are to be hidden until the object is in a safe place, then the operation of FIG. 4 might be used. For example, the existence of a classified document on an employee's person might be detectable while the employee is carrying the document out of a secured area in a closed briefcase (e.g., the transmitted code would only indicate the presence of a secure document), but opening the document within the secured area would cause the tag to respond with a different code that could identify the specifics of the document.

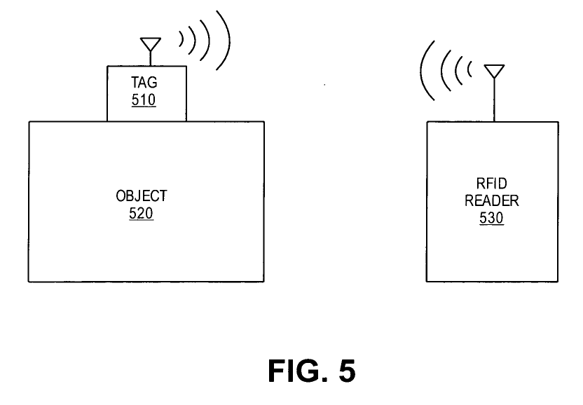

FIG. 5 shows a system with an object to be identified by an associated RFID tag, according to an embodiment of the invention. RFID tag 510 may have a light sensor to control its response to a query from RFID reader 530. RFID tag 510 may be attached to an object 520, with the intent of permitting the RFID reader 530 to identify the object 520 through its association with RFID tag 510. Controlling the characteristics of the light reaching the light sensor may be used to permit the RFID reader 530 to be aware (or not be aware) of the proximity of the object 520, or alternately may be used to permit the reader, or an associated computer system, to be aware of the proximity of the object and determine (or not determine) details of the object 520 by looking up the received identification code in a database. The object may be any suitable object, such as but not limited to: 1) a document, 2) a label, 3) a piece of equipment, 4) a container, 5) perishable goods, 6) etc.

The foregoing description is intended to be illustrative and not limiting. Variations will occur to those of skill in the art. Those variations are intended to be included in the various embodiments of the invention, which are limited only by the spirit and scope of the following claims.

What is claimed is:

1. An apparatus, comprising:
a radio frequency identification (RFID) tag circuit to be activated by a received signal from an RFID reader; and
a light sensor coupled to the RFID tag circuit, the light sensor to control transmission through an antenna from the activated RFID tag circuit based on detection of light by the light sensor.

2. The apparatus of claim 1, wherein the light sensor is to produce an output signal to the RFID tag circuit to indicate whether the detected light has certain characteristics.

3. The apparatus of claim 2, wherein the certain characteristics are based at least partly on intensity of the detected light.

4. The apparatus of claim 2, wherein the certain characteristics are based at least partly on wavelengths of the detected light.

5. The apparatus of claim 2, wherein the certain characteristics are based at least partly on duration of the detected light.

6. The apparatus of claim 2, wherein the output signal is to have at least a first state and a second state.

7. The apparatus of claim 6, wherein:
the RFID tag circuit has an identification code; and
the first state is to indicate the identification code is to be transmitted from the activated RFID tag circuit and the second state is to indicate the identification code is not to be transmitted from the activated RFID tag circuit.

8. The apparatus of claim 6, wherein:
the RFID tag circuit has a first identification code and a second identification code; and
the first state is to indicate the first identification code is to be transmitted from the activated RFID tag circuit and the second state is to indicate the second identification code is to be transmitted from the activated RFID tag circuit.

9. The apparatus of claim 2, wherein:
the light sensor comprises at least two light detectors; and
the RFID tag comprises circuitry to combine a signal from each of the at least two light detectors to generate the output signal.

10. The apparatus of claim 1, wherein:
the light sensor comprises a photovoltaic cell to provide operational power to the RFID tag circuit.

11. The apparatus of claim 1, further comprising the antenna.

12. A method, comprising:
receiving a radio signal;
activating a radio frequency identification (RFID) tag circuit based on said receiving; and
transmitting a response to the radio signal based on a state of an output signal from a light sensor.

13. The method of claim 12, wherein said transmitting comprises:
transmitting an identification code in the response if the output signal from the light sensor has a first state; and
not transmitting the response if the output signal from the light sensor has a second state.

14. The method of claim 12, wherein said transmitting comprises:
transmitting a first identification code in the response if the output signal from the light sensor has a first state; and
transmitting a second identification code in the response if the output signal from the light sensor has a second state.

15. A system, comprising:
a radio frequency identification (RFID) tag circuit to be activated by a received signal from an RFID reader;
a light sensor coupled to the RFID tag circuit, the light sensor to control transmission of at least one identification code through an antenna from the activated RFID tag circuit based on detection of light by the light sensor; and
an object coupled to the RFID tag circuit, the object to be identified by association with the at least one identification code.

16. The system of claim 15, wherein the light sensor is to produce an output signal to the RFID tag circuit to indicate whether the detected light has certain characteristics.

17. The system of claim 16, wherein the certain characteristics are based at least partly on characteristics selected from a list consisting of intensity of the detected light, wavelengths of the detected light, and duration of the detected light.

18. The system of claim 16, wherein the output signal is to have at least a first state and a second state.

19. The system of claim 18, wherein:
the RFID tag circuit has an identification code; and
the first state is to indicate the identification code is to be transmitted and the second state is to indicate the identification code is not to be transmitted.

20. The system of claim 18, wherein:
the RFID tag circuit has a first identification code and a second identification code; and
the first state is to indicate the first identification code is to be transmitted and the second state is to indicate the second identification code is to be transmitted.

21. The system of claim 15, wherein the light sensor comprises a photovoltaic cell to provide operational power to the RFID tag circuit
